(19) United States
(12) Patent Application Publication
(10) Pub. No.: US 2016/0056706 A1
(43) Pub. Date: Feb. 25, 2016

(54) MATRIX CONVERTER, MATRIX CONVERTER CONTROL DEVICE AND MATRIX CONVERTER CONTROL METHOD

(71) Applicant: KABUSHIKI KAISHA YASKAWA DENKI, Kitakyushu-shi (JP)

(72) Inventor: Kentaro INOMATA, Fukuoka (JP)

(73) Assignee: KABUSHIKI KAISHA YASKAWA DENKI, Kitakyushu-shi (JP)

(21) Appl. No.: 14/831,876

(22) Filed: Aug. 21, 2015

(30) Foreign Application Priority Data
Aug. 25, 2014 (JP) 2014-170942

(51) Int. Cl. H02M 1/00; H02M 5/293

(52) U.S. Cl. CPC H02M 1/00; H02M 5/293; H02M 2001/0003

(57) ABSTRACT

A matrix converter includes a selector, a commutation controller, a determinator, and a condition changer. The selector selects one commutation pattern from plurality of commutation patterns based on a state of a phase voltage of a AC power source and a state of a phase current of a load. The commutation controller performs commutation control by controlling bidirectional switches pursuant to the commutation pattern selected by the selector to switch a connection state of the AC power source and the load. The determinator determines a power loss generated by the commutation control in the bidirectional switches. The condition changer changes the commutation patterns which become a selection target of the selector or a selection condition of the commutation patterns which become the selection target of the selector, based on the power loss determined by the determinator.

### CROSS-REFERENCE TO RELATED APPLICATIONS

The present disclosure contains subject matter related to that disclosed in Japanese Priority Patent Application No. 2014-170942 filed with the Japan Patent Office on Aug. 25, 2014, the entire contents of which are incorporated herein by reference.

### BACKGROUND OF THE INVENTION

1. Field of the Invention

An embodiment disclosed herein relates to a matrix converter, a matrix converter control device and a matrix converter control method.

2. Description of the Related Art

A matrix converter includes a plurality of bidirectional switches which interconnects an AC power source and a load. By controlling the bidirectional switches and directly switching the respective phase voltages of the AC power source, the matrix converter outputs an arbitrary voltage and an arbitrary frequency to the load.

By individually on/off controlling the switching elements constituting the bidirectional switches in a predetermined order, the matrix converter performs commutation control by which to switch a connection state of the phase of the load and the phase of the AC power source. This makes it possible to prevent, for example, the inter-phase short circuit of the AC power source or the opening of the output phase.

As commutation methods used in commutation control, there are proposed many different commutation methods including a four-step voltage commutation method and a four-step current commutation method. Furthermore, there is proposed a method in which, by combining a plurality of commutation methods, the commutation methods used in commutation control are switched depending on the state of a phase voltage of an AC power source or the state of a phase current of a load (see, e.g., Japanese Patent Application Publication No. 2010-246174).

However, depending on, e.g., the combining method of the commutation methods or the switching condition of the commutation methods, there is a fear that a power loss generated in bidirectional switches becomes larger.

### SUMMARY OF THE INVENTION

In accordance with an aspect, there is provided a matrix converter including: a power converter including a plurality of bidirectional switches provided between respective phases of an AC power source and respective phases of a load; a selector configured to select one commutation pattern from plurality of commutation patterns based on a state of a phase voltage of the AC power source and a state of a phase current of the load; a commutation controller configured to perform commutation control by controlling the bidirectional switches pursuant to the commutation pattern selected by the selector to switch a connection state of the AC power source and the load; a determinator configured to determine a power loss generated by the commutation control in the bidirectional switches;

and a condition changer configured to change the commutation patterns which become a selection target of the selector or a selection condition of the commutation patterns which become the selection target of the selector, based on the power loss determined by the determinator.

### BRIEF DESCRIPTION OF THE DRAWINGS

FIG. 1 is a diagram illustrating a configuration example of a matrix converter according to an embodiment.

FIG. 2 is a diagram illustrating a configuration example of a bidirectional switch.

FIG. 3 is a diagram illustrating one example of the switching of input phase voltages outputted to respective output phases.

FIG. 4 is a diagram illustrating a corresponding relationship between unidirectional switches of a plurality of bidirectional switches and gate signals.

FIG. 5A is a diagram illustrating a relationship between an output phase voltage and gate signals in the case where an output phase current is positive in a four-step current commutation method.

FIG. 5B is a diagram illustrating a relationship between an output phase voltage and gate signals in the case where an output phase current is negative in a four-step current commutation method.

FIG. 6 is a diagram illustrating the states of unidirectional switches in the four-step current commutation method illustrated in FIG. 5A.

FIG. 7 is a diagram illustrating a relationship between an output phase voltage, gate signals and respective steps of a commutation operation in a four-step voltage commutation method.

FIG. 8 is a diagram illustrating the states of unidirectional switches in the four-step voltage commutation method illustrated in FIG. 7.

FIG. 9A is a diagram illustrating a relationship between an output phase voltage and gate signals in a three-step current commutation method.

FIG. 9B is a diagram illustrating a relationship between an output phase voltage and gate signals in a three-step current commutation method.

FIG. 10A is a diagram illustrating a relationship between an output phase voltage and gate signals in a three-step voltage commutation method.

FIG. 10B is a diagram illustrating a relationship between an output phase voltage and gate signals in a three-step voltage commutation method.

FIG. 11A is a diagram illustrating a relationship between an output phase voltage and gate signals in a pseudo three-step current commutation method.

FIG. 11B is a diagram illustrating a relationship between an output phase voltage and gate signals in a pseudo three-step current commutation method.

FIG. 12A is a diagram illustrating a relationship between an output phase voltage and gate signals in a three-step voltage/current commutation method.

FIG. 12B is a diagram illustrating a relationship between an output phase voltage and gate signals in a three-step voltage/current commutation method.

FIG. 13A is a diagram illustrating a relationship between an output phase voltage and gate signals in a two-step current commutation method.

FIG. 13B is a diagram illustrating a relationship between an output phase voltage and gate signals in a two-step current commutation method.

FIG. 14 is a diagram illustrating a relationship between an output phase voltage, gate signals and respective steps of a commutation operation in a first two-step voltage commutation method.

FIG. 15A is a diagram illustrating a relationship between an output phase voltage and gate signals in a second two-step voltage commutation method.

FIG. 15B is a diagram illustrating a relationship between an output phase voltage and gate signals in a second two-step voltage commutation method.

FIG. 16A is a diagram illustrating a relationship between an output phase voltage and gate signals in a third two-step voltage commutation method.

FIG. 16B is a diagram illustrating a relationship between an output phase voltage and gate signals in a third two-step voltage commutation method.

FIG. 17A is a diagram illustrating a relationship between an output phase voltage and gate signals in a one-step current commutation method.

FIG. 17B is a diagram illustrating a relationship between an output phase voltage and gate signals in a one-step current commutation method.

FIG. 18A is a diagram illustrating a relationship between an output phase voltage and gate signals in a pseudo one-step current commutation method.

FIG. 18B is a diagram illustrating a relationship between an output phase voltage and gate signals in a pseudo one-step current commutation method.

FIG. 19A is a diagram illustrating a flow of an output phase current in the case where both unidirectional switches are turned on.

FIG. 19B is a diagram illustrating a flow of an output phase current in the case where one unidirectional switch is turned on and the other unidirectional switch is turned off.

FIG. 20 is a diagram illustrating a relationship between a switching loss and a conduction loss in the respective commutation methods.

FIG. 21 is a diagram illustrating a configuration example of a control unit.

FIG. 22 is a diagram illustrating a selection example of commutation methods using a commutation unit.

FIG. 23 is a diagram illustrating one example of a configuration of a commutation unit.

FIG. 24 is a diagram illustrating a relationship between an output phase current and a predetermined range.

FIG. 25 is a diagram illustrating a relationship between an input phase voltage and a predetermined range.

FIG. 26 is a diagram illustrating another example of a configuration of a commutation unit.

FIG. 27 is a diagram illustrating a change example of a selection ratio with respect to a power loss.

FIG. 28 is a flowchart illustrating one example of a flow of a control process performed by a control unit.

### DESCRIPTION OF THE EMBODIMENTS

An embodiment of a matrix converter, a matrix converter control device and a matrix converter control method disclosed herein will now be described in detail with reference to the accompanying drawings. The present disclosure is not limited to the embodiment to be described below.

[1. Configuration of Matrix Converter]

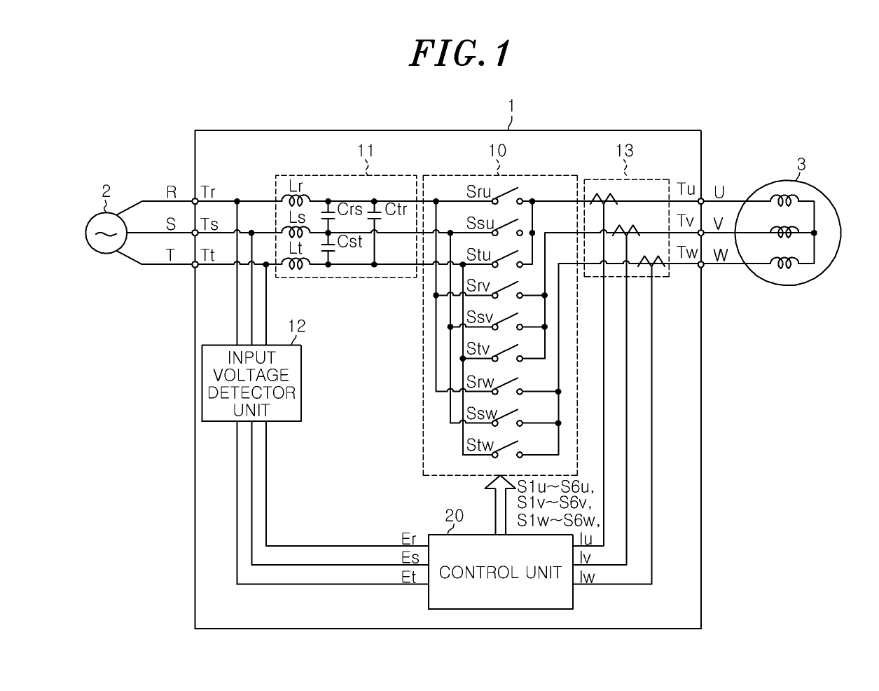

FIG. 1 is a diagram illustrating a configuration example of a matrix converter according to an embodiment. As illustrated in FIG. 1, the matrix converter 1 according to an embodiment is provided between a three-phase AC power source 2 (hereinafter simply referred to as an AC power source 2) and a load 3. The AC power source 2 is, e.g., a power system. The load 3 is, e.g., an AC motor or an AC generator. In the following descriptions, the R-phase, S-phase and T-phase of the AC power source 2 will be referred to as input phases, and the U-phase, V-phase and W-phase of the load 3 will be referred to as output phases.

The matrix converter 1 includes input terminals Tr, Ts and Tt, output terminals Tu, Tv and Tw, a power converter 10, an LC filter 11, an input voltage detector unit 12, an output current detector unit 13 and a control unit (e.g., a controller) 20. The matrix converter 1 converts a three-phase AC voltage supplied from the AC power source 2 via the input terminals Tr, Is and Tt to a three-phase AC voltage having an arbitrary voltage and an arbitrary frequency, and outputs the converted three-phase AC voltage from the output terminals Tu, Tv and Tw to the load 3.

The power converter 10 includes a plurality of bidirectional switches Sru, Ssu, Stu, Srv, Ssv, Stv, Srw, Ssw and Stw (hereinafter often generically referred to as a bidirectional switch S) which interconnects the respective phases of the AC power source 2 and the respective phases of the load 3.

The bidirectional switches Sru, Ssu and Stu interconnect the R-phase, S-phase and T-phase of the AC power source 2 and the U-phase of the load 3. The bidirectional switches Srv, Ssv and Stv interconnect the R-phase, S-phase and T-phase of the AC power source 2 and the V-phase of the load 3. The bidirectional switches Srw, Ssw and Stw interconnect the R-phase, S-phase and T-phase of the AC power source 2 and the W-phase of the load 3.

FIG. 2 is a diagram illustrating a configuration example of the bidirectional switch S. As illustrated in FIG. 2, for example, the bidirectional switch S is configured by serially connecting a parallel connection circuit of a unidirectional switch Sio and a diode Doi and a parallel connection circuit of a unidirectional switch Soi and a diode Doi.

It is only necessary that the unidirectional switch S is configured to include a plurality of unidirectional switches and is capable of controlling the conduction direction thereof. The unidirectional switch S is not limited to the configuration illustrated in FIG. 2. For example, the bidirectional switch S may be configured by parallel connecting a serial connection circuit of a unidirectional switch Sio and a diode Doi and a serial connection circuit of a unidirectional switch Soi and a diode Doi.

The unidirectional switches Sio and Soi are semiconductor switching elements, for example, unipolar transistors such as MOSFETs (Metal-Oxide-Semiconductor Field-Effect Transistors) or the like. The unidirectional switches Sio and Soi may be, e.g., wide-gap semiconductor switching elements such as FETs made of GaN, MOSFETs made of SiC, or the like. Furthermore, the unidirectional switches Sio and Soi may be, e.g., semiconductor switching elements such as IGBTs (Insulated Gate Bipolar Transistors) or the like.

Referring back to FIG. 1, the matrix converter 1 will be further described. The LC filter 11 is provided between the R-phase, S-phase and T-phase of the AC power source 2 and the power converter 10. The LC filter 11 includes three reactors Lr, Ls and Lt and three capacitors Crs, Cst and Ctr. The LC filter 11 serves to remove a high-frequency component generated due to the switching of the bidirectional switch S.

The input voltage detector unit 12 detects the respective phase voltages of the R-phase, S-phase and T-phase of the AC power source 2. For example, the input voltage detector unit 12 detects instantaneous values Er, Es and Et (hereinafter referred to as input phase voltages Er, Es and Et) of the respective phase voltages of the R-phase, S-phase and T-phase of the AC power source 2.

The output current detector unit 13 detects a current flowing between the power converter 10 and the load 3. For example, the output current detector unit 13 detects instantaneous values Iu, Iv and Iw (hereinafter referred to as output phase currents Iu, Iv and Iw) of the current flowing between the power converter 10 and the U-phase, V-phase and W-phase of the load 3.

In the following descriptions, the respective phase voltages of the R-phase, S-phase and T-phase of the AC power source 2 will be often generically referred to as an input phase voltage Vi, and the output phase currents Iu, Iv and Iw will be often generically referred to as an output phase current Io. In addition, the voltages outputted from the power converter 10 to the U-phase, V-phase and W-phase of the load 3 will be often referred to as output phase voltages Vu, Vv and Vw.

The control unit 20 generates gate signals S1u to S6u, S1v to S6v and S1w to S6w based on the input phase voltages Er, Es and Et and the output phase currents Iu, Iv and Iw.

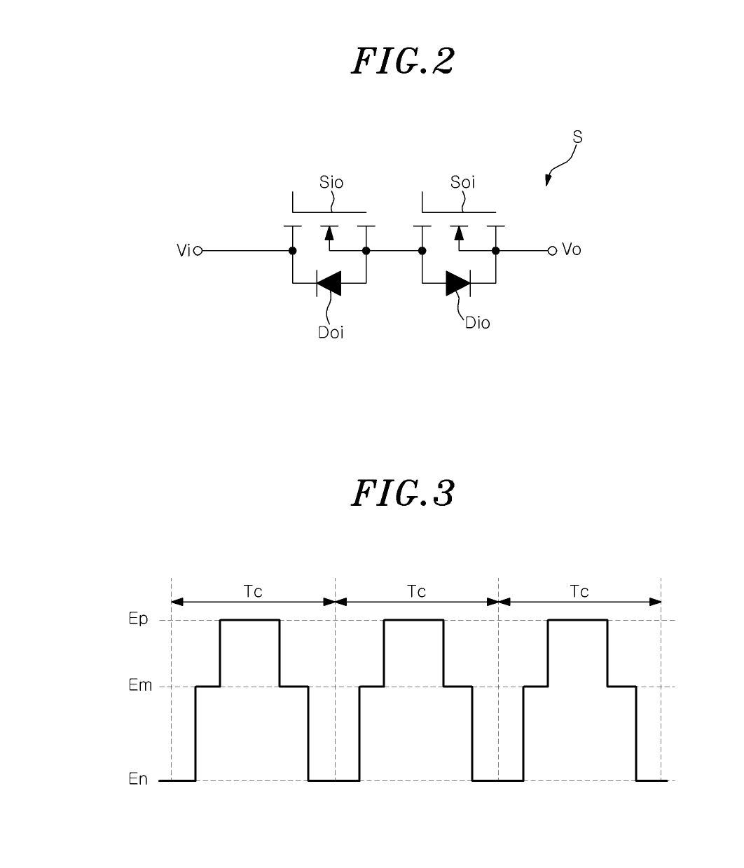

FIG. 3 is a diagram illustrating one example of the switching of the input phase voltages Ep, Em and En outputted to the respective output phases. The input phase voltage Ep is a largest input phase voltage among the input phase voltages Er, Es and Et. The input phase voltage Em is an intermediate input phase voltage among the input phase voltages Er, Es and Et. The input phase voltage En is a smallest input phase voltage among the input phase voltages Er, Es and Et.

As illustrated in FIG. 3, by virtue of the control of the bidirectional switch S using the gate signals S1u to S6u, S1v to S6v and S1w to S6w, for example, the input phase voltages outputted to the respective output phases are switched in the order of En, Em, Ep, Em and En during every carrier period Tc of a PWM voltage command. The switching of the input phase voltages outputted to the respective output phases may vary depending on the commutation pattern and is not limited to the one illustrated in FIG. 3.

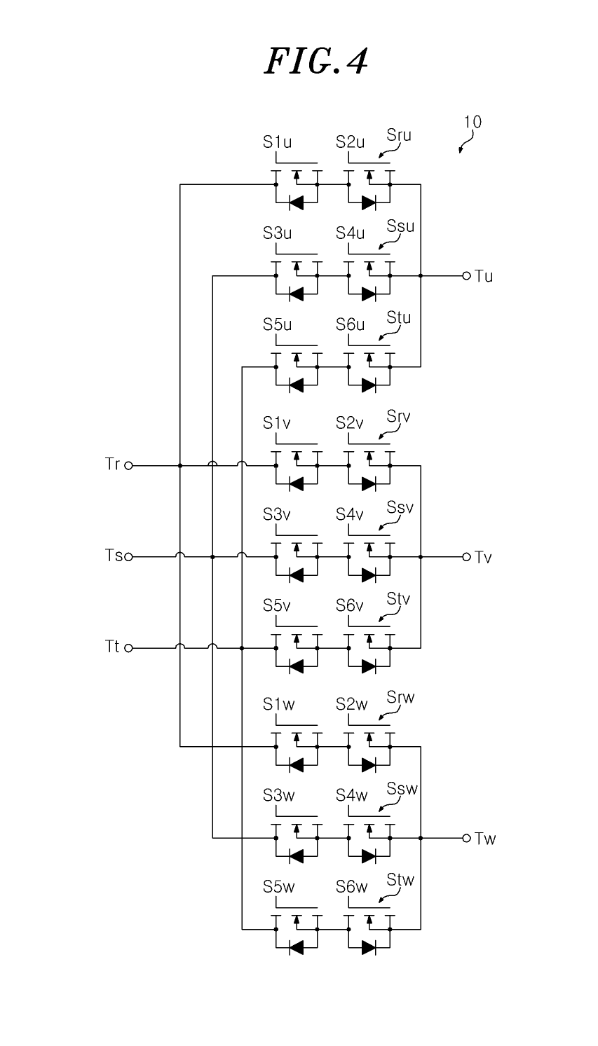

FIG. 4 is a diagram illustrating a corresponding relationship between the unidirectional switches Sio and Soi of the bidirectional switches Sru, Ssu, Stu, Srv, Ssv, Stv, Srw, Ssw and Stw and the gate signals S1u to S6u, S1v to S6v and S1w to S6w. In FIG. 4, the LC filter 11 and the output current detector unit 13 are omitted.

The unidirectional switches Sio (see FIG. 2) of the bidirectional switches Sru, Ssu and Stu are respectively controlled by the gate signals S1u, S3u and S5u. The unidirectional switches Soi (see FIG. 2) of the bidirectional switches Sru, Ssu and Stu are respectively controlled by the gate signals S2u, S4u and S6u.

The control unit 20 performs commutation control by which the connection state of the AC power source 2 and the load 3 is switched by selecting one commutation pattern from plural kinds commutation patterns based on at least one of the state of the input phase voltage Vi and the state of the output phase current Io and controlling the bidirectional switch S according to the selected commutation pattern. The commutation pattern which becomes a selection target of the control unit 20 is selected so as to suppress an increase of a power loss generated in the bidirectional switch S. Hereinafter, the kinds of the commutation patterns, the power loss generated in the bidirectional switch S, and the control unit 20 will be described one after another.

[2. Commutation Pattern]

Commutation patterns vary depending on the commutation methods. Examples of the commutation methods include a four-step current commutation method, a four-step voltage commutation method, a three-step current commutation method, a three-step voltage commutation method, a pseudo three-step current commutation method, a three-step voltage/current commutation method, a two-step current commutation method, first to third two-step voltage commutation methods, a one-step current commutation method, and a pseudo one-step current commutation method. Hereinafter, the commutation patterns of these commutation methods will be described.

(Commutation Pattern of Four-Step Current Commutation Method)

In the four-step current commutation method, in order to prevent the short circuit between the input phases and the opening of the output phases, depending on the polarity of the output phase current Io, commutation control is performed in the commutation pattern composed of the following Steps 1 to 4.

Step 1: Among the unidirectional switches that constitute the bidirectional switch S serving as a switching source, the unidirectional switch having a polarity opposite to that of the output phase current Io is turned off.

Step 2: Among the unidirectional switches that constitute the bidirectional switch S serving as a switching destination, the unidirectional switch having the same polarity as that of the output phase current Io is turned on.

Step 3: Among the unidirectional switches that constitute the bidirectional switch S serving as a switching source, the unidirectional switch having the same polarity as that of the output phase current Io is turned off.

Step 4: Among the unidirectional switches that constitute the bidirectional switch S serving as a switching destination, the unidirectional switch having a polarity opposite to that of the output phase current Io is turned on.

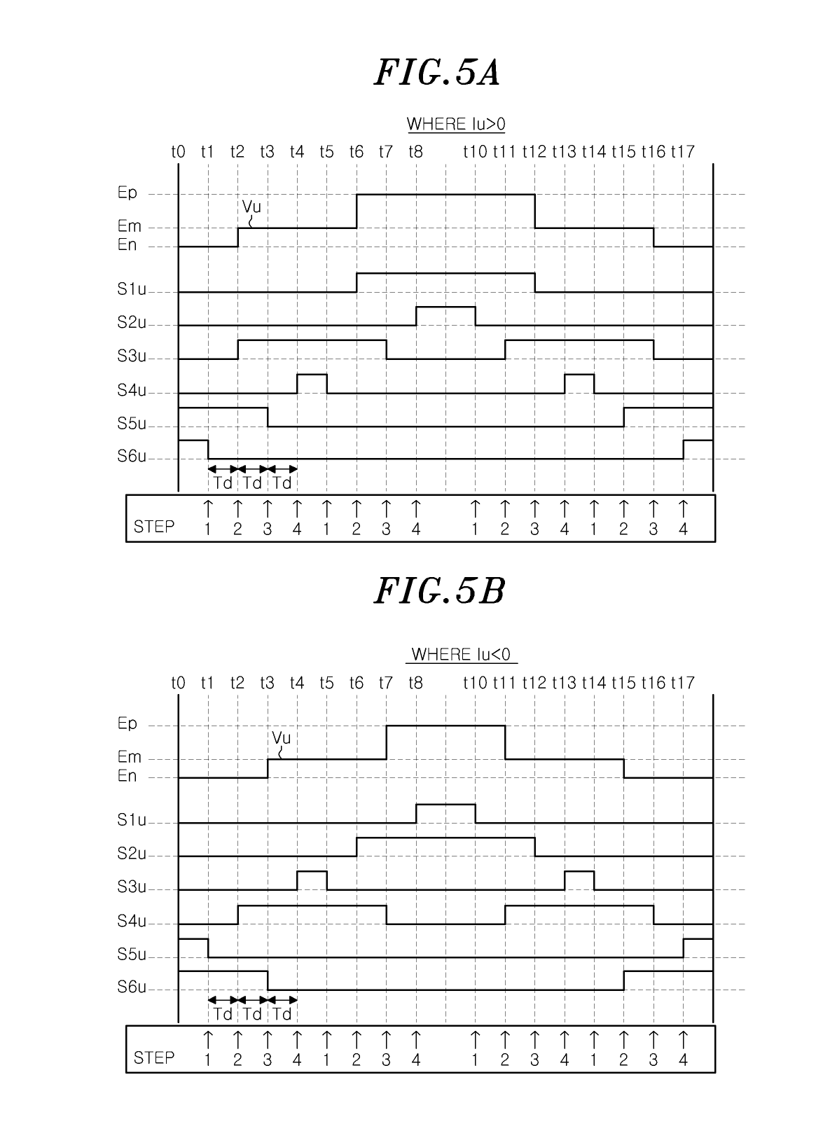

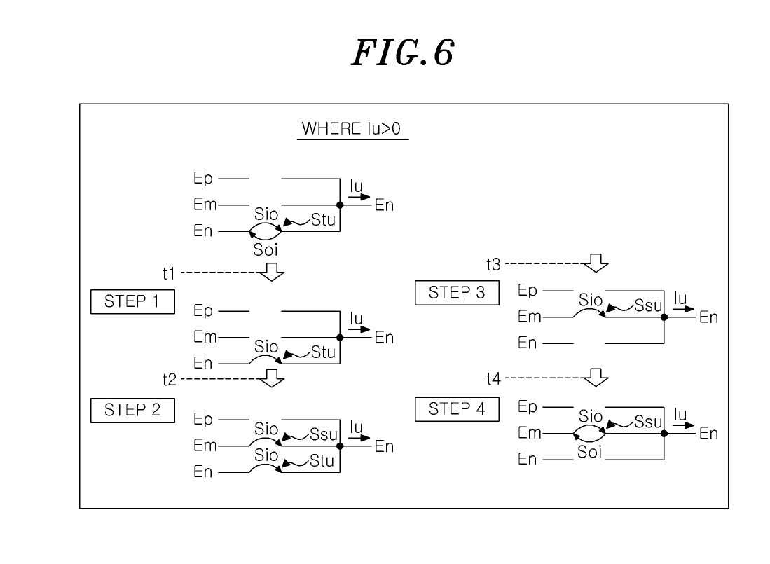

The commutation control using the four-step current commutation method is executed as illustrated in FIGS. 5A and 5B. FIGS. 5A and 5B are diagrams illustrating a relationship between the output phase voltage Vu and the gate signals S1u to S6u in the four-step current commutation method. FIG. 5A illustrates commutation control in the case where the output phase current Iu is positive, and FIG. 5B illustrates commutation control in the case where the output phase current Iu is negative. FIG. 6 is a diagram illustrating the states of the unidirectional switches Sio and Soi at time points t1 to t4 illustrated in FIG. 5A. It is assumed that Ep=Er, Em=Es, and En=Et.

(Commutation Pattern of Four-Step Voltage Commutation Method)

In the four-step voltage commutation method, in order to prevent the short circuit between the input phases and the opening of the output phases, depending on the magnitude relationship of the input phase voltages Er, Es and Et, commutation control is performed in the commutation pattern composed of the following Steps 1 to 4.

Step 1: The reverse-biased unidirectional switch serving as a switching destination is turned on.

Step 2: The reverse-biased unidirectional switch serving as a switching source is turned off.

Step 3: The forward-biased unidirectional switch serving as a switching destination is turned on.

Step 4: The forward-biased unidirectional switch serving as a switching source is turned off.

In the unidirectional switch Sio, the state in which an input-side voltage is lower than an output-side voltage immediately prior to commutation control is referred to as reverse-biased, and the state in which an input-side voltage is higher than an output-side voltage immediately prior to commutation control is referred to as forward-biased. In the unidirectional switch Soi, the state in which an input-side voltage is lower than an output-side voltage immediately prior to commutation control is referred to as forward-biased, and the state in which an input-side voltage is higher than an output-side voltage immediately prior to commutation control is referred to as reverse-biased.

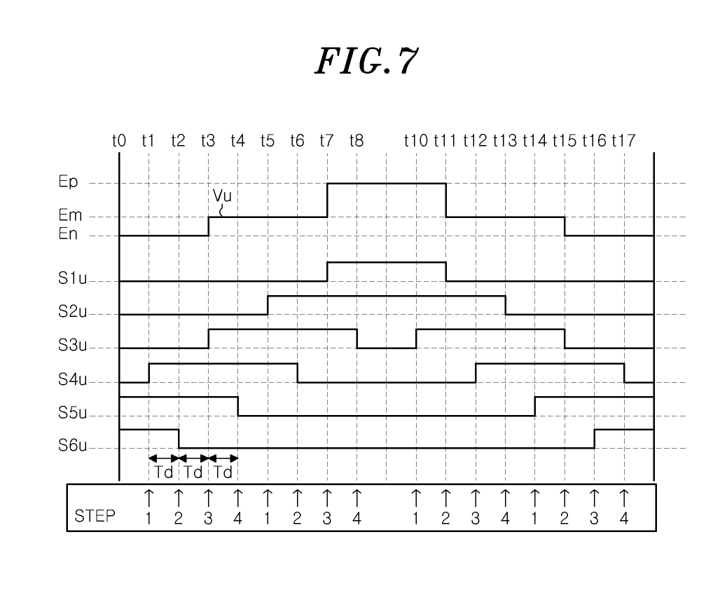

The commutation control using the four-step voltage commutation method is executed as illustrated in FIG. 7. FIG. 7 is a diagram illustrating a relationship between the output phase voltage Vu, the gate signals S1u to S6u and the respective steps of the commutation control in the four-step voltage commutation method. FIG. 8 is a diagram illustrating the states of the unidirectional switches Sio and Soi at time points t1 to t4 illustrated in FIG. 7. It is assumed that Ep=Er, Em=Es, and En=Et.

(Commutation Pattern of Three-Step Current Commutation Method)

The three-step current commutation method is a commutation method in which the input phase voltages outputted to the respective output phases at three steps are switched depending on the magnitude relationship between the input phase voltages Er, Es and Et and the polarity of the output phase current Io. The three-step current commutation method simultaneously performs two steps among four steps of the four-step current commutation method. The three-step current commutation method simultaneously performs a step of turning off one of the two reverse-biased unidirectional switches and a step of turning on the other reverse-biased unidirectional switch, among Steps 1 to 4 of the four-step current commutation method.

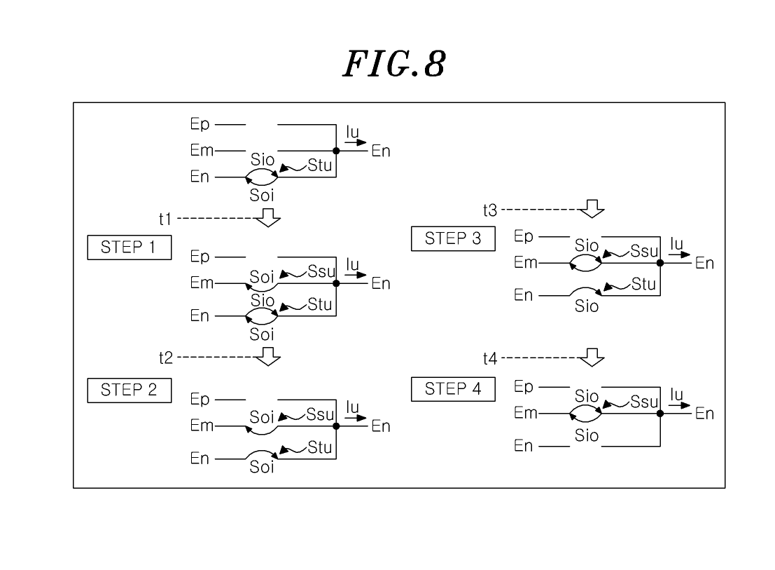

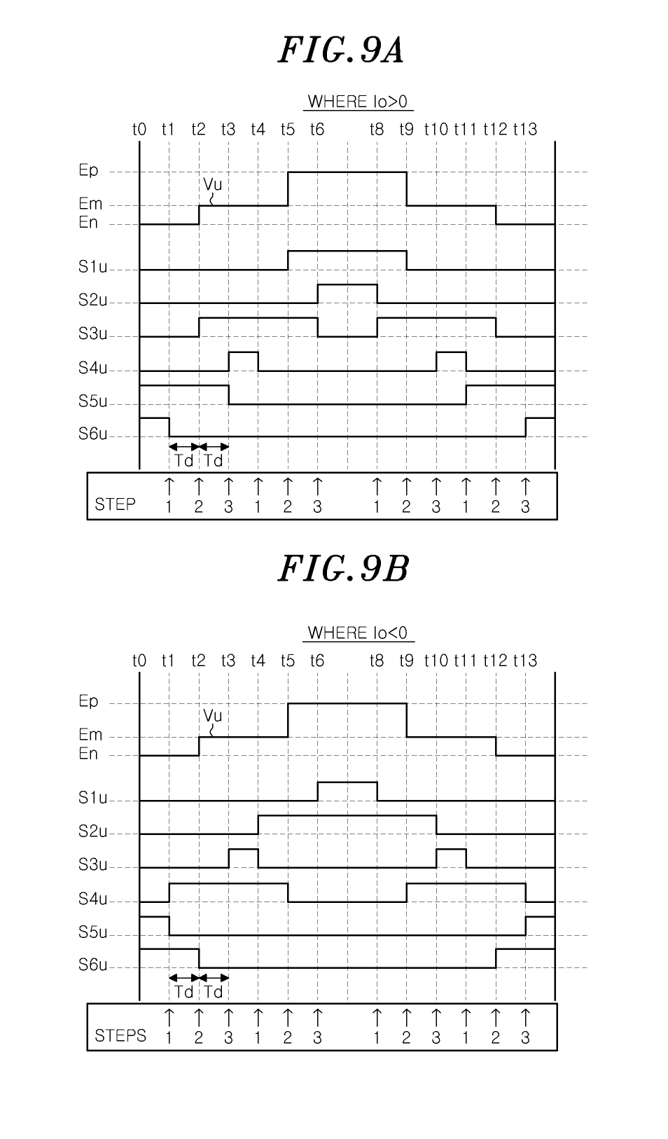

The commutation control using the three-step current commutation method is executed as illustrated in FIGS. 9A and 9B. FIGS. 9A and 9B are diagrams corresponding to FIGS. 5A and 5B and illustrating a relationship between the output phase voltage Vu, the gate signals S1u to S6u and the respective steps of the commutation control in the three-step current commutation method.

(Commutation Pattern of Three-Step Voltage Commutation Method)

The three-step voltage commutation method is a commutation method in which the input phase voltages outputted to the respective output phases at three steps are switched depending on the magnitude relationship between the input phase voltages Er, Es and Et and the polarity of the output phase current Io. The three-step voltage commutation method simultaneously performs two steps among four steps of the four-step voltage commutation method. The three-step voltage commutation method simultaneously performs a step of turning off the switch having a polarity opposite to that of the output phase current Io and a step of turning on the switch having a polarity opposite to that of the output phase current Io, among Steps 1 to 4 of the four-step voltage commutation method.

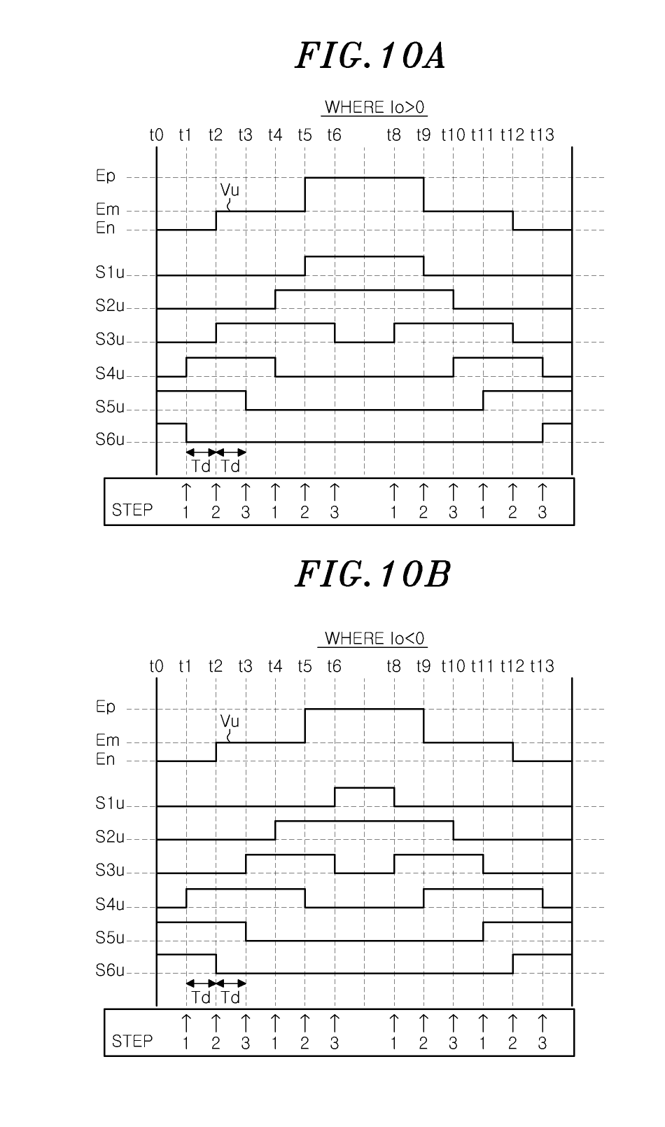

The commutation control using the three-step voltage commutation method is executed as illustrated in FIGS. 10A and 10B. FIGS. 10A and 10B are diagrams corresponding to FIGS. 5A and 5B and illustrating a relationship between the output phase voltage Vu, the gate signals S1u to S6u and the respective steps of the commutation control in the three-step voltage commutation method.

(Commutation Pattern of Pseudo Three-Step Current Commutation Method)

The pseudo three-step current commutation method is a commutation method in which the input phase voltages outputted to the respective output phases at three steps are switched depending on the polarity of the output phase current Io. The pseudo three-step voltage commutation method simultaneously performs a step of turning off one of the two switches having the same polarity as that of the output phase current Io and a step of turning on the other switch, among Steps 1 to 4 of the four-step current commutation method.

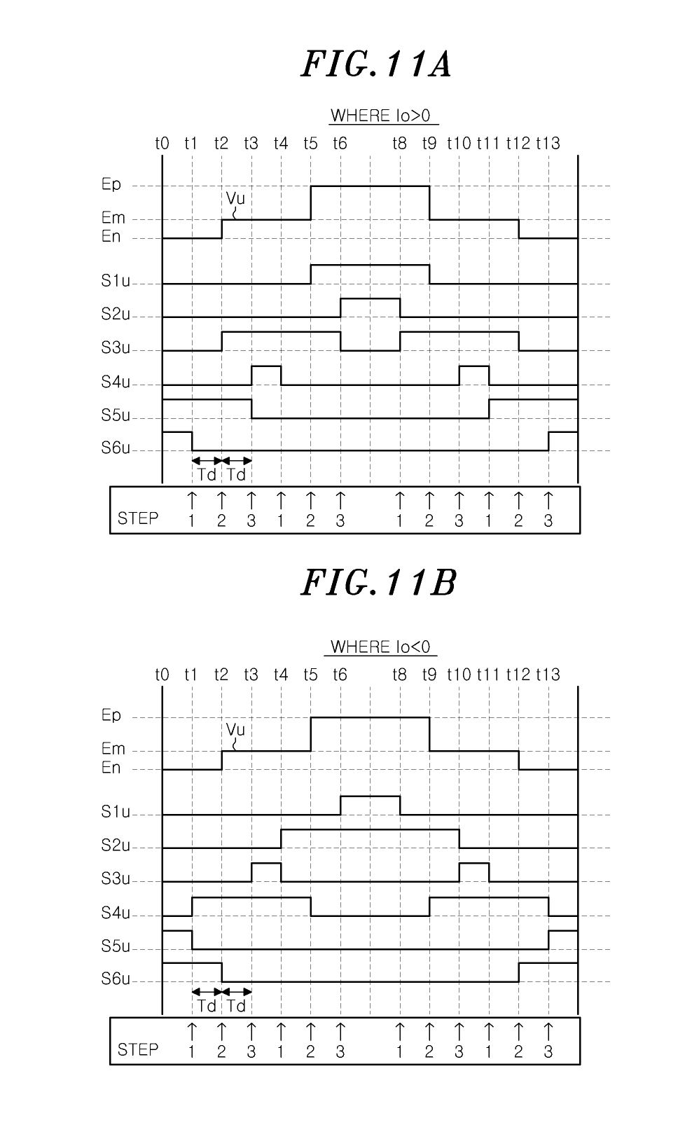

The commutation control using the pseudo three-step current commutation method is executed as illustrated in FIGS. 11A and 11B. FIGS. 11A and 11B are diagrams corresponding to FIGS. 5A and 5B and illustrating a relationship between the output phase voltage Vu, the gate signals S1u to S6u and the respective steps of the commutation control in the three-step current commutation method.

(Commutation Pattern of Three-Step Voltage/Current Commutation Method)

The three-step voltage/current commutation method is a commutation method in which the input phase voltages outputted to the respective output phases at three steps are switched depending on the magnitude relationship between the input phase voltages Er, Es and Et and the polarity of the output phase current Io. Steps 1 to 3 of the three-step voltage/current commutation method are, e.g., combinations of some of Steps 1 to 3 of the three-step current commutation method and some of Steps 1 to 3 of the three-step voltage commutation method.

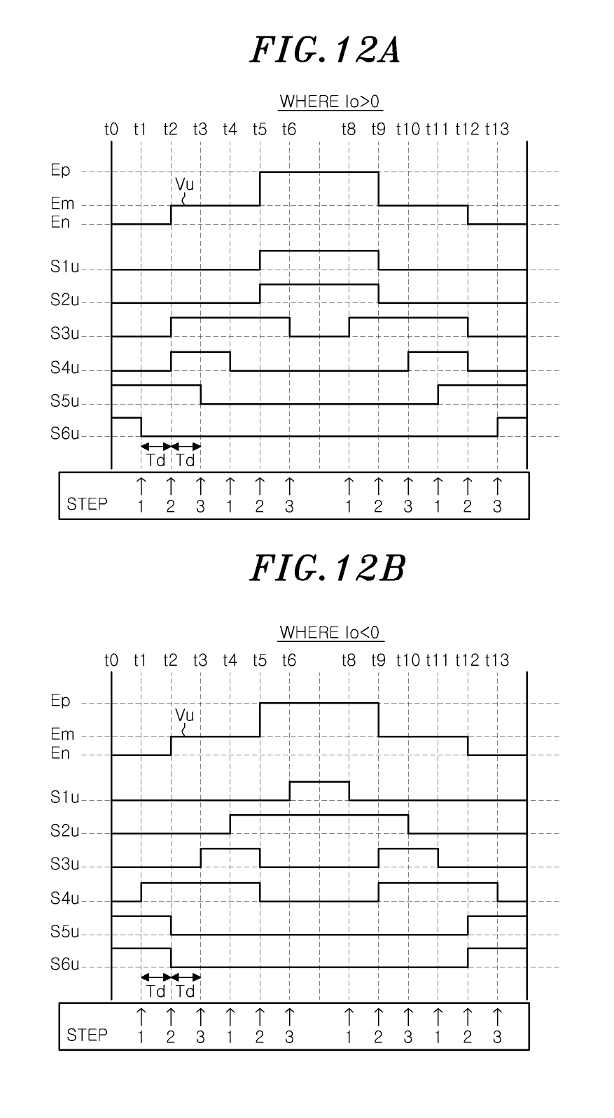

The commutation control using the three-step voltage/current commutation method is executed as illustrated in FIGS. 12A and 12B. FIGS. 12A and 12B are diagrams corresponding to FIGS. 5A and 5B and illustrating a relationship between the output phase voltage Vu, the gate signals S1u to S6u and the respective steps of the commutation control in the three-step voltage/current commutation method.

(Commutation Pattern of Two-Step Current Commutation Method)

The two-step current commutation method is a commutation method in which the input phase voltages outputted to the respective output phases at two steps are switched depending on the polarity of the output phase current Io. The two-step current commutation method turns on the unidirectional switch having the same polarity as that of the output phase current Io among the bidirectional switches S serving as switching destinations (Step 1). Thereafter, the two-step current commutation method turns off the unidirectional switch having the same polarity as that of the output phase current Io among the bidirectional switches S serving as switching sources (Step 2).

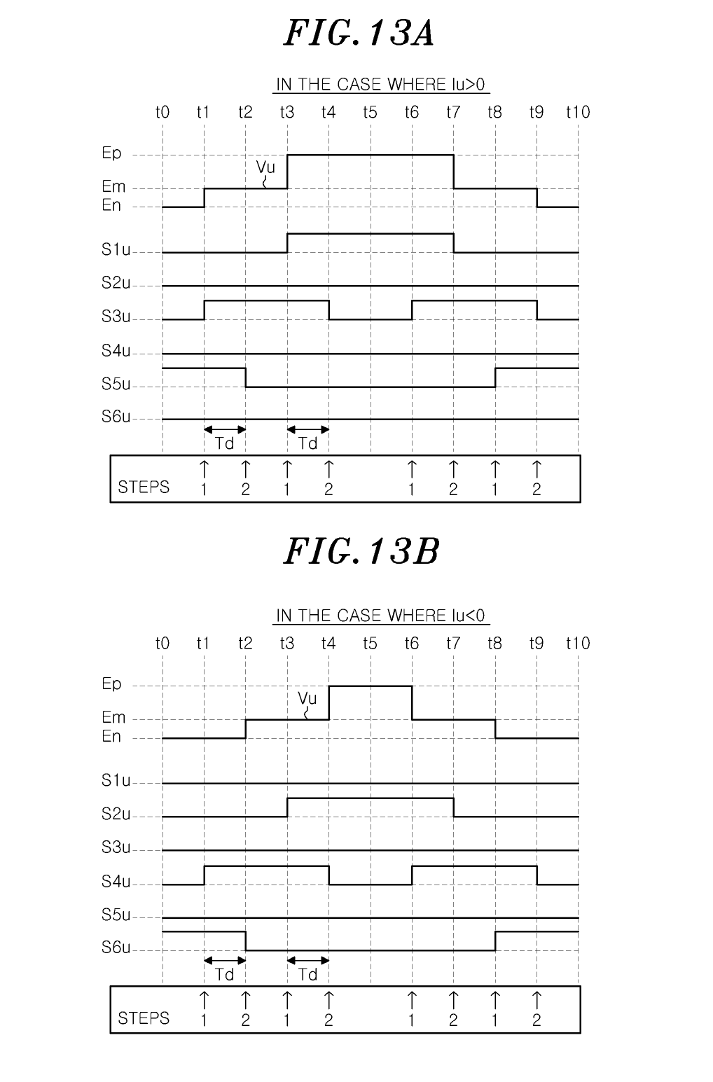

The commutation control using the two-step current commutation method is executed as illustrated in FIGS. 13A and 13B. FIGS. 13A and 13B are diagrams corresponding to FIGS. 5A and 5B and illustrating a relationship between the output phase voltage Vu, the gate signals S1u to S6u and the respective steps of the commutation control in the two-step current commutation method.

(Commutation Pattern of First two-Step Voltage Commutation Method)

The first two-step voltage commutation method is a voltage commutation method in which the input phase voltages outputted to the respective output phases at two steps are switched depending on the magnitude relationship between the input phase voltages Er, Es and Et. For example, when switching the input phase voltages in the order of En, Em and Ep, the first two-step voltage commutation method turns off the unidirectional switch Soi serving as a switching source and turns on the unidirectional switch Sio serving as a switching destination. Furthermore, when switching the input phase voltages in the order of Ep, Em and En, the first two-step voltage commutation method turns off the unidirectional switch Sio serving as a switching source and turns on the unidirectional switch Soi serving as a switching destination.

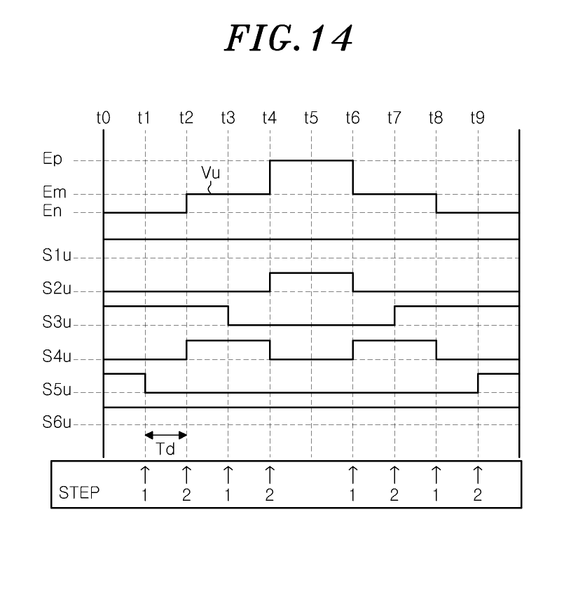

The commutation control using the first two-step voltage commutation method is executed as illustrated in, e.g., FIG. 14. FIG. 14 is a diagram corresponding to FIG. 7 and illustrating a relationship between the output phase voltage Vu, the gate signals S1u to S6u and the respective steps of the commutation control in the first two-step voltage commutation method.

(Commutation Pattern of Second two-Step Voltage Commutation Method)

The second two-step voltage commutation method is a voltage commutation method in which the input phase voltages outputted to the respective output phases at two steps are switched depending on the magnitude relationship between the inter-phase voltages of the input phases. The second two-step voltage commutation method is a commutation method in which commutation at a minimum inter-phase voltage of the input phases is banned.

The commutation control using the second two-step voltage commutation method is executed as illustrated in

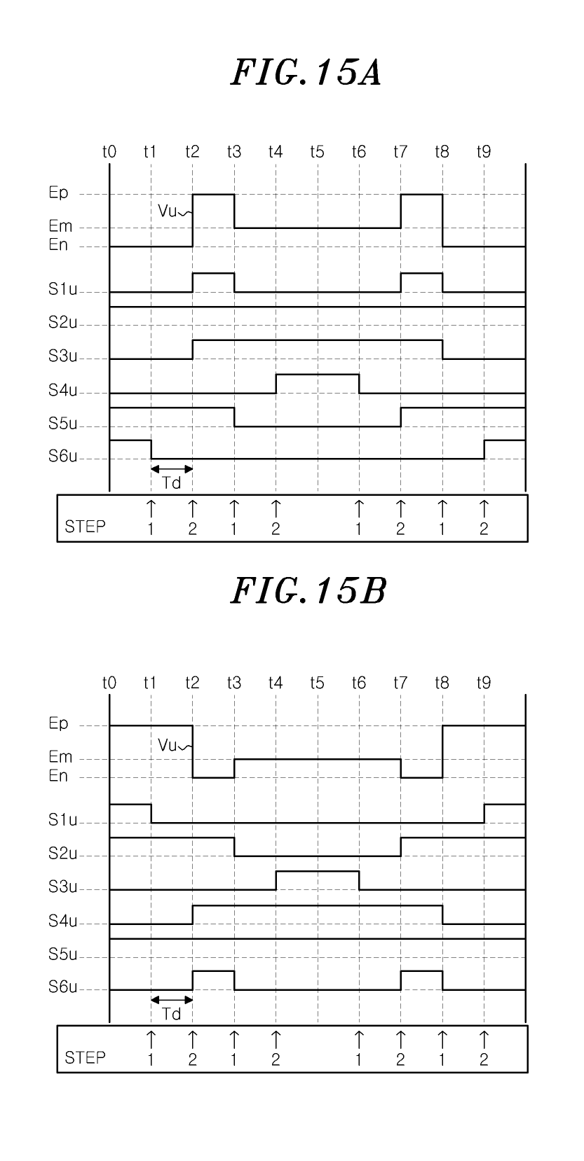

FIGS. 15A and 15B. FIGS. 15A and 15B are diagrams corresponding to FIG. 7 and illustrating a relationship between the output phase voltage Vu, the gate signals S1u to S6u and the respective steps of the commutation control in the second two-step voltage commutation method. FIG. 15A illustrates a case where Ep−Em>Em−En, and FIG. 15B illustrates a case where Ep−Em<Em−En.

(Commutation Pattern of Third two-Step Voltage Commutation Method)

The third two-step voltage commutation method is a voltage commutation method in which the input phase voltages outputted to the respective output phases at two steps are switched depending on the magnitude relationship between the inter-phase voltages of the input phases.

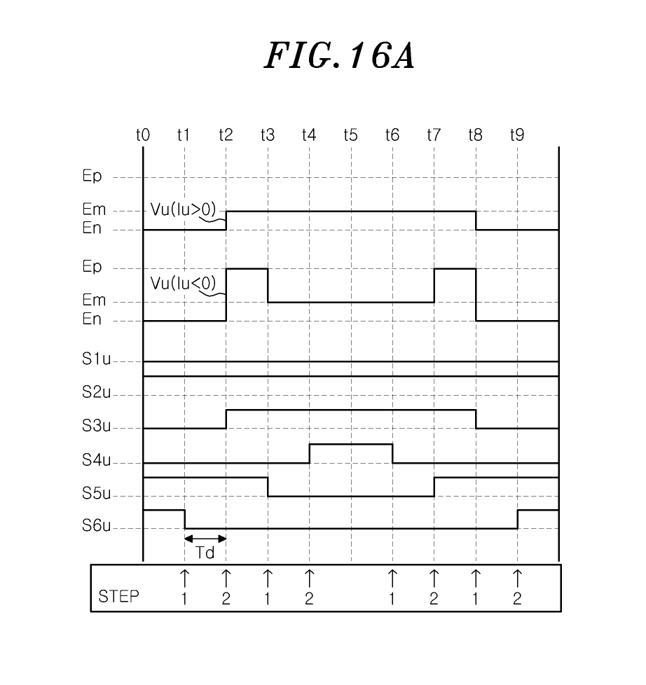

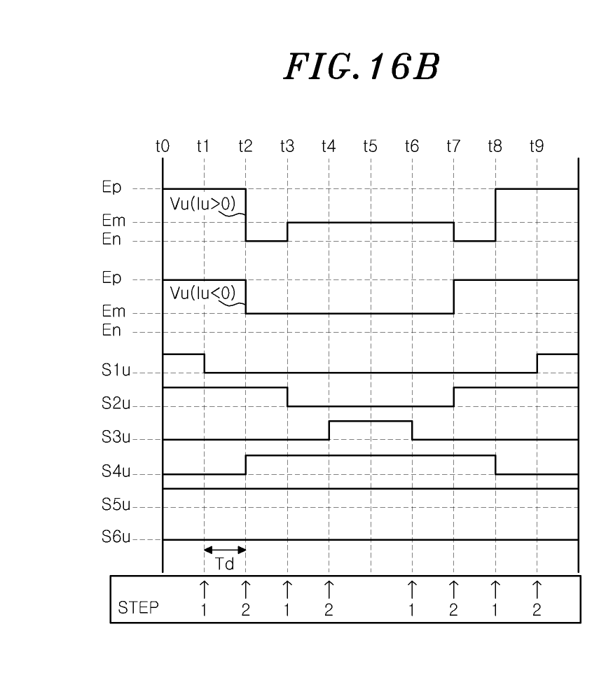

The commutation control using the third two-step voltage commutation method is executed as illustrated in, e.g., FIGS. 16A and 16B. FIGS. 16A and 16B are diagrams corresponding to FIG. 7 and illustrating a relationship between the output phase voltage Vu, the gate signals S1u to S6u and the respective steps of the commutation control in the third two-step voltage commutation method. FIG. 16A illustrates a case where Ep−Em>Em−En, and FIG. 16B illustrates a case where Ep−Em<Em−En.

(Commutation Pattern of One-Step Current Commutation Method)

The one-step current commutation method is a commutation method in which the input phase voltages outputted to the respective output phases at every step are switched depending on the magnitude relationship between the input phase voltages Er, Es and Et and the polarity of the output phase current Io. The one-step current commutation method is, e.g., a commutation method which sequentially turns on the forward-biased unidirectional switches having the same polarity as that of the output phase current Io or sequentially turns off the reverse-biased unidirectional switches having the same polarity as that of the output phase current Io.

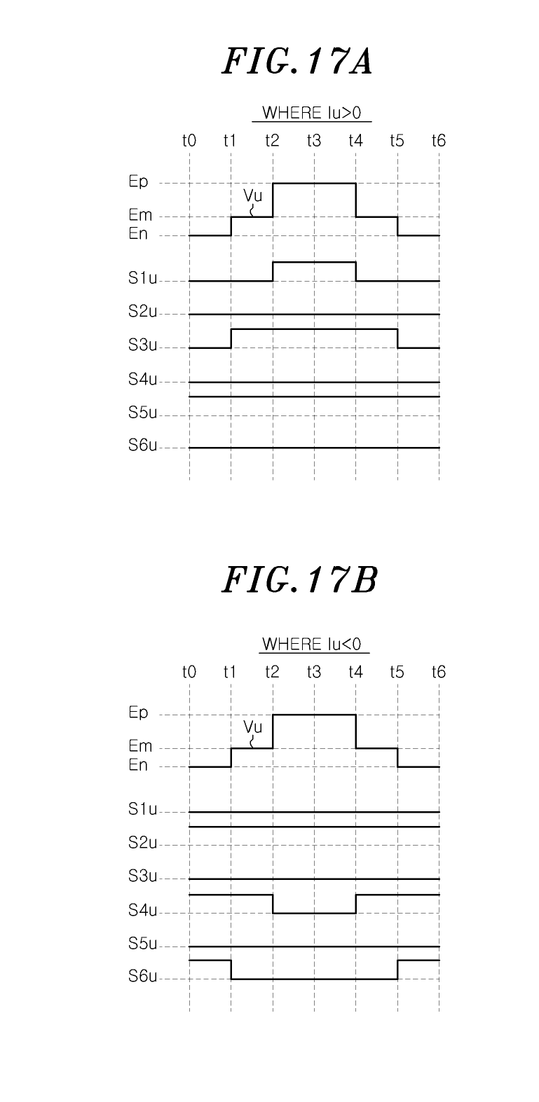

The commutation control using the one-step current commutation method is executed as illustrated in, e.g., FIGS. 17A and 17B. FIGS. 17A and 17B are diagrams corresponding to FIGS. 5A and 5B and illustrating a relationship between the output phase voltage Vu, the gate signals S1u to S6u and the respective steps of the commutation control in the one-step current commutation method.

(Commutation Pattern of Pseudo One-Step Current Commutation Method)

The pseudo one-step current commutation method is a commutation method in which the input phase voltages outputted to the respective output phases at every step are switched depending on the polarity of the output phase current Io. The pseudo one-step current commutation method is, e.g., a commutation method which switches the unidirectional switch having the same polarity as that of the output phase current Io.

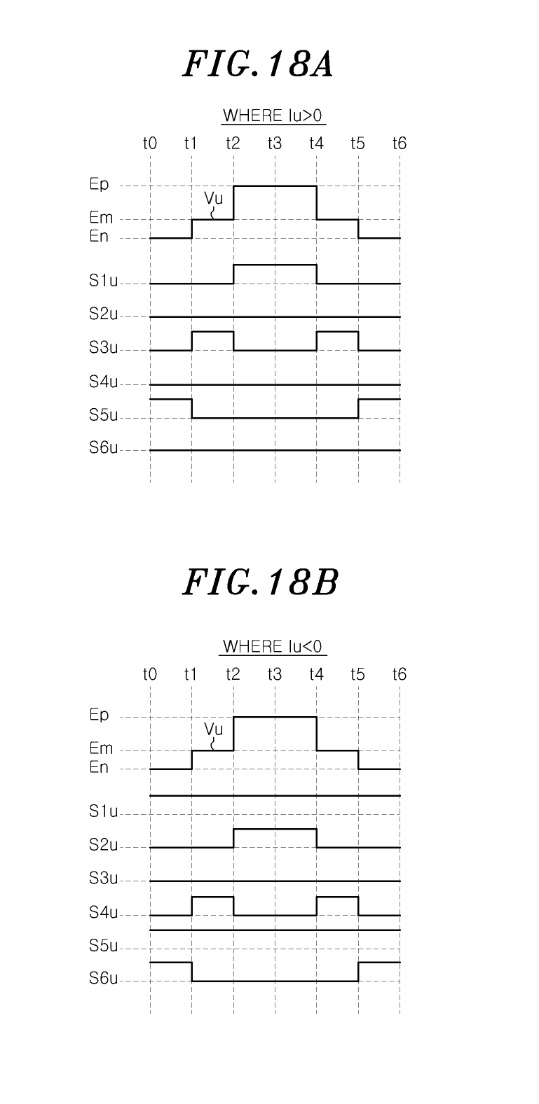

The commutation control using the pseudo one-step current commutation method is executed as illustrated in, e.g., FIGS. 18A and 18B. FIGS. 18A and 18B are diagrams corresponding to FIGS. 5A and 5B and illustrating a relationship between the output phase voltage Vu, the gate signals S1u to S6u and the respective steps of the commutation control in the pseudo one-step current commutation method.

[3. Power Loss Generated in Bidirectional Switch S]

Next, descriptions will be made on the power loss generated in the bidirectional switch S. The power loss generated in the bidirectional switch S includes a conduction loss and a switching loss.

First, the conduction loss will be described. If the unidirectional switches Sio and Soi are unipolar transistors, there may be a case where, during the commutation control, one of the unidirectional switches Sio and Soi constituting the bidirectional switch S is turned on and the other is turned off. In this case, as compared with a case where all the unidirectional switches Sio and Soi are turned on, the conduction loss becomes larger.

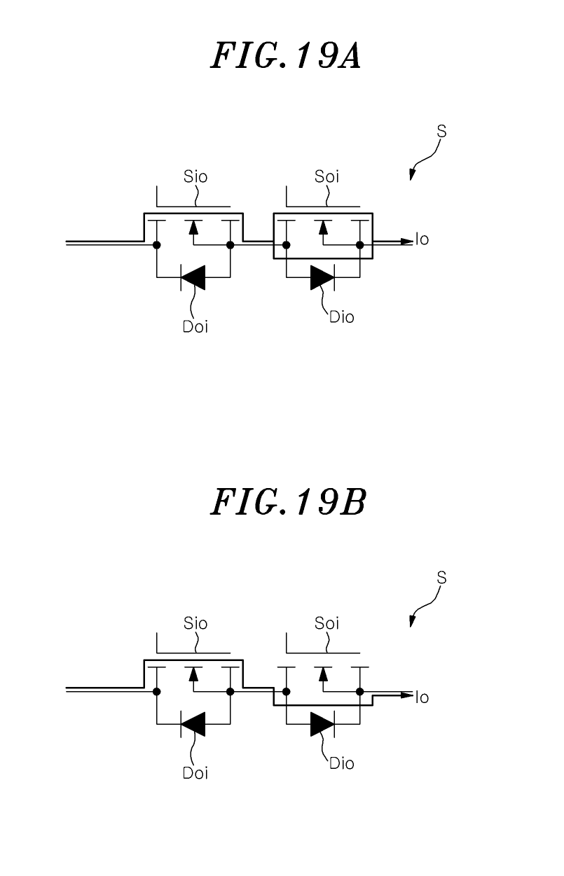

FIG. 19A is a diagram illustrating a flow of the output phase current Io in the case where both the unidirectional switches Sio and Soi are turned on, and FIG. 19B is a diagram illustrating a flow of the output phase current Io in the case where the unidirectional switch Sio is turned on and the unidirectional switch Soi is turned off.

If the unidirectional switches Sio and Soi constituting the bidirectional switch S are turned on as illustrated in FIG. 19A, the output phase current Io flows through the unidirectional switch Sio and divisionally flows through the unidirectional switch Soi and the diode Dio.

On the other hand, if the unidirectional switch Sio is turned on and the unidirectional switch Soi is turned off as illustrated in FIG. 19B, the output phase current Io flows toward the diode Dio through the unidirectional switch Sio. The conduction loss generated by the forward voltage Vf of the diode Dio is larger than the conduction loss generated by the on-resistance of the unidirectional switch Soi. For that reason, the conduction loss becomes larger in the case illustrated in FIG. 19B than in the case illustrated in FIG. 19A.

Since the conduction loss becomes larger as the output phase current Io grows larger, the conduction loss becomes smaller as the time period during which the conduction direction of the bidirectional switch S is made bidirectional grows longer. Accordingly, in order to reduce the conduction loss, it is preferred that the time period during which the conduction direction of the bidirectional switch S is made bidirectional is set as long as possible.

Next, descriptions will be made on the switching loss generated in the bidirectional switch S. The term “switching loss” used herein means the electric power consumed in the unidirectional switches Sio and Soi when the unidirectional switches Sio and Soi constituting the bidirectional switch S are turned on and off.

In the case of the second two-step voltage commutation, the switching loss increases in the commutation method which bans commutation at a minimum inter-phase voltage of the input phases. For example, as illustrated in FIG. 15A, the commutation pattern becomes En→Ep→Em→Ep→En. Thus, the switching is performed in a state in which the line voltage remains high. For example, as compared with the four-step current commutation method, the switching loss increases 1.5 to 2 times.

This switching loss is equally generated not only in the case where the unidirectional switches Sio and Soi are unipolar transistors but also in the case where the unidirectional switches Sio and Soi are IGBTs.

FIG. 20 is a diagram illustrating a relationship between the switching loss and the conduction loss in the respective commutation methods. As illustrated in FIG. 20, the switching loss and the conduction loss vary depending on the commutation methods. The difference in the conduction loss is small in the case where the unidirectional switches Sio and Soi are IGBTs.

[4. Configuration of Control Unit 20]

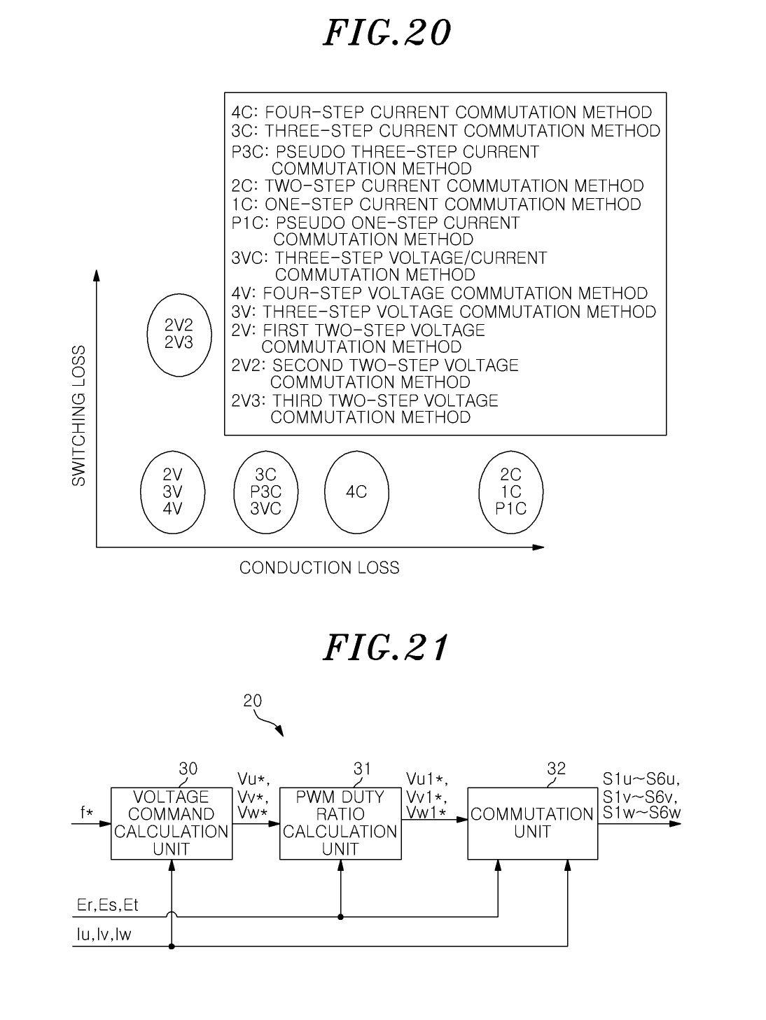

FIG. 21 is a diagram illustrating a configuration example of the control unit 20. As illustrated in FIG. 21, the control unit 20 includes a voltage command calculation unit 30, a PWM duty ratio calculation unit 31 and a commutation unit 32.

The control unit 20 includes a microcomputer, which includes a CPU (Central Processing Unit), a ROM (Read Only Memory), a RAM (Random Access Memory), an input/output port and the like, and various kinds of circuits. By reading and executing a program stored in the ROM, the CPU of the microcomputer functions as the voltage command calculation unit 30, the PWM duty ratio calculation unit 31 and the commutation unit 32.

Alternatively, at least one or all of the voltage command calculation unit 30, the PWM duty ratio calculation unit 31 and the commutation unit 32 may be configured by hardware such as an ASIC (Application Specific Integrated Circuit), an FPGA(Field Programmable Gate Array) or the like.

[4.1. Voltage Command Calculation Unit 30]

The voltage command calculation unit 30 generates and outputs voltage commands Vu*, Vv* and Vw* of the respective output phases based on the frequency commands f* and the output phase currents Iu, Iv and Iw. The frequency commands f* are commands of the frequencies of the output phase voltages Vu, Vv and Vw.

[4.2. PWM Duty Ratio Calculation Unit 31]

The PWM duty ratio calculation unit 31 generates PWM voltage commands Vu1*, Vv1* and Vw1* based on the voltage commands Vu*, Vv* and Vw* and the input phase voltages Er, Es and Et. The technique of generating the PWM voltage commands Vu1*, Vv1* and Vw1* is well-known in the art. For example, the techniques disclosed in Japanese Patent Application Publication Nos. 2008-048550 and 2012-239265 may be used as the technique of generating the PWM voltage commands Vu1*, Vv1* and Vw1*.

For example, in the time period during which the magnitude relationship between the input phase voltages Er, Es and Et remains unchanged, the PWM duty ratio calculation unit 31 set an input phase voltage having a largest magnitude among the input phase voltages Er, Es and Et as the input phase voltage Ep. The PWM duty ratio calculation unit 31 set an input phase voltage having an intermediate magnitude among the input phase voltages Er, Es and Et as the input phase voltage Em and set an input phase voltage having a smallest magnitude among the input phase voltages Er, Es and Et as the input phase voltage En. The PWM duty ratio calculation unit 31 converts the voltage commands Vu*, Vv* and Vw* to pulse width modulation signals corresponding to the respective voltage values of the input phase voltages Ep, Em and En and outputs the pulse width modulation signals as the PWM voltage commands Vu1*, Vv1* and Vw1*.

[4.3. Commutation Unit 32]

The commutation unit 32 executes commutation control by which the input phases connected to the output phases are switched by the bidirectional switch S. For example, the commutation unit 32 selects one of the commutation methods A to D based on at least one of the polarity of each of the output phase currents Iu, Iv and Iw and the magnitude relationship between the input phase voltages Er, Es and Et. The commutation unit 32 generates gate signals Stu to S6u, S1v to S6v and S1w to S6w from the PWM voltage commands Vu1*, Vv1* and Vw1* so that commutation is performed in the order pursuant to the commutation pattern of the selected commutation method.

In the following descriptions, the polarity of each of the output phase currents Iu, Iv and Iw will be often referred to as an output current polarity, and the magnitude relationship between the input phase voltages Er, Es and Et will be often referred to as an input voltage rank. Furthermore, the gate signals Stu to S6u, S1v to S6v and S1w to S6w will be often generically referred to as a gate signal Sg.

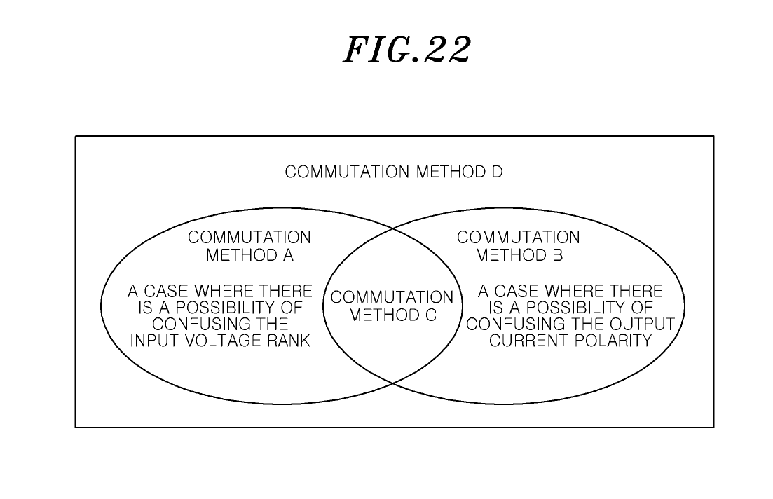

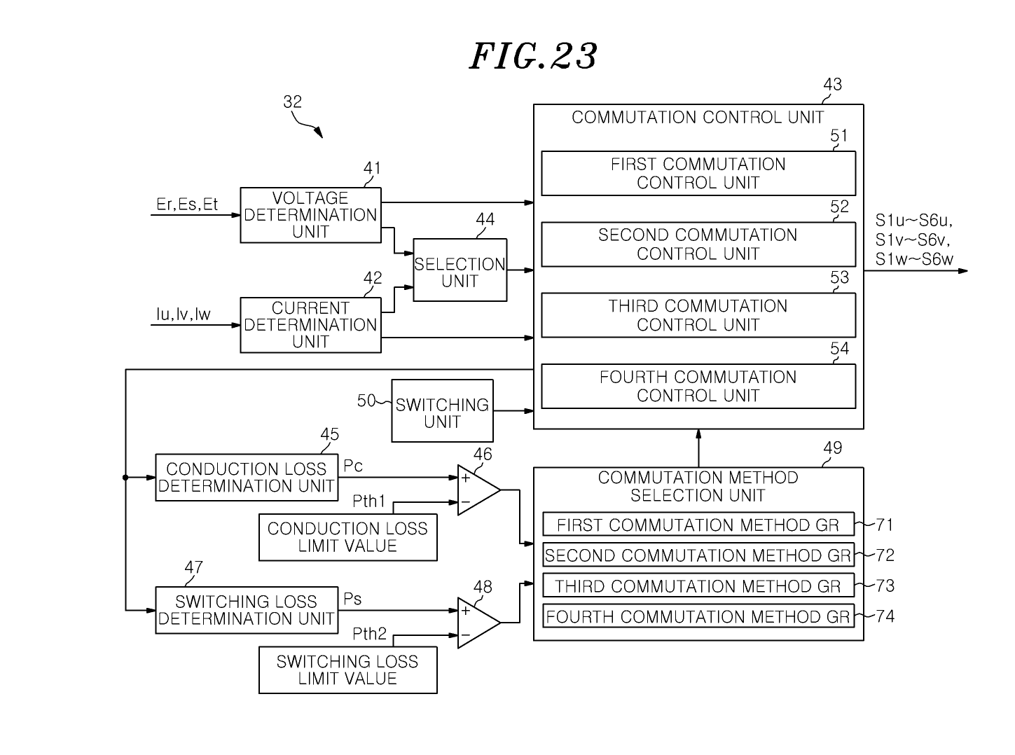

FIG. 22 is a diagram illustrating a selection example of the commutation methods using the commutation unit 32. As illustrated in FIG. 22, for example, if there is a possibility of confusing the input voltage rank, the commutation unit 32 selects commutation method A. If there is a possibility of confusing the output current polarity, the commutation unit 32 selects commutation method B. Furthermore, if there is a possibility of confusing both the input voltage rank and the output current polarity, the commutation unit 32 does not select commutation methods A and B but selects commutation method C. In addition, if there is no possibility of confusing both the input voltage rank and the output current polarity, the commutation unit 32 selects commutation method D.

FIG. 23 is a diagram illustrating one example of the configuration of the commutation unit 32. As illustrated in FIG. 23, the commutation unit 32 includes a voltage determination unit 41, a current determination unit 42, a commutation control unit (e.g., a commutation controller) 43, a selection unit (e.g., a selector) 44, a conduction loss determination unit (e.g., a conduction loss determinator) 45, comparison units 46 and 48, a switching loss determination unit (e.g., a switching loss determinator) 47, a commutation method selection unit 49 (one example of a condition changer), and a switching unit (e.g., switcher) 50. Instead of including both the conduction loss determination unit 45 and the switching loss determination unit 47, the commutation unit 32 may include only the conduction loss determination unit 45 or only the switching loss determination unit 47.

The voltage determination unit 41 determines the input voltage rank and notifies the determination result to the commutation control unit 43. As illustrated in FIG. 24, the voltage determination unit 41 determines whether the inter-phase voltage of the input phases (e.g., the voltage between the R-phase and the S-phase) falls within a predetermined range RA. FIG. 24 is a diagram illustrating a relationship between the input phase voltages Er, Es and Et and the predetermined range RA. The voltage determination unit 41 may determine, based on the phase θi of the input phase voltage Vi, whether the inter-phase voltage of the input phases falls within the predetermined range RA.

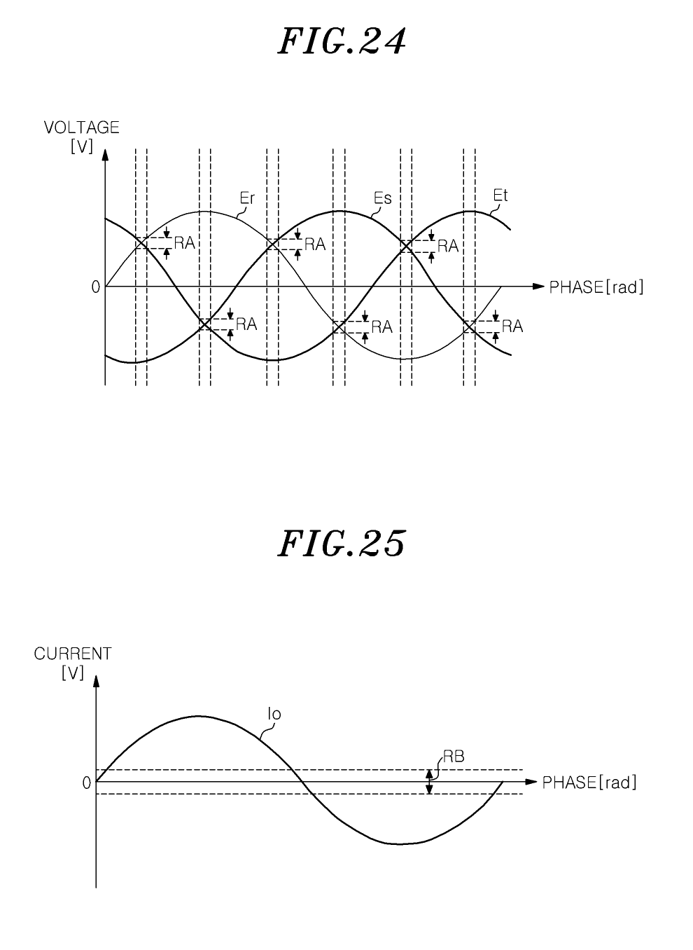

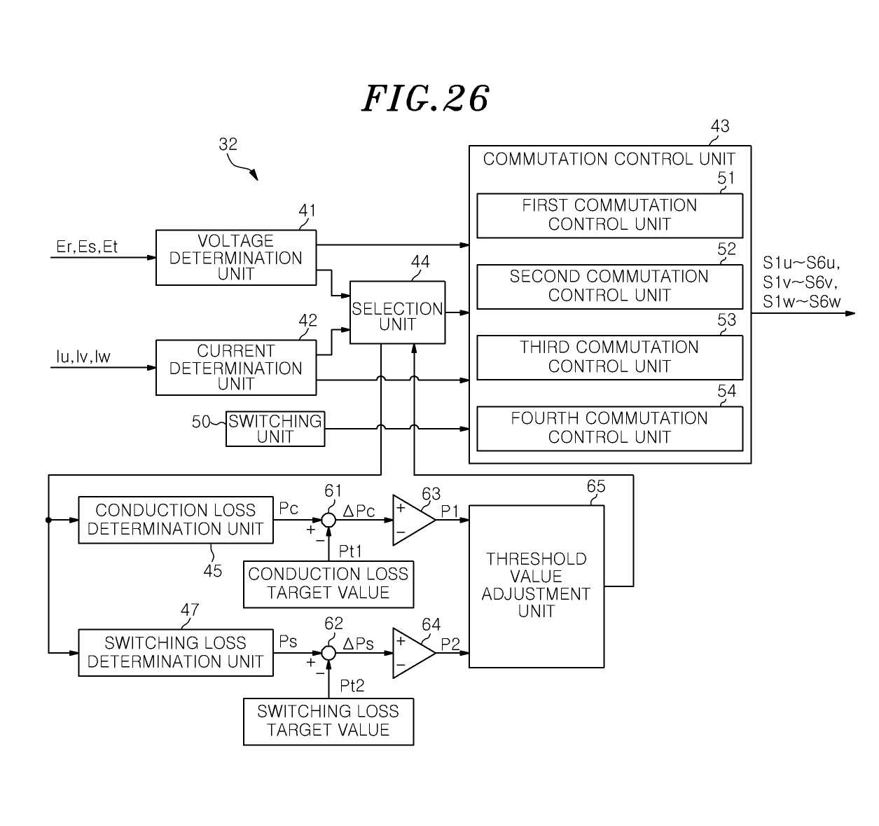

The current determination unit 42 determines the output current polarity and notifies the determination result to the commutation control unit 43. As illustrated in FIG. 25, the current determination unit 42 determines whether the output phase current Io falls within a predetermined range RB including zero. FIG. 25 is a diagram illustrating a relationship between the output phase current Io and the predetermined range RB. The current determination unit 42 may determine, based on the phase θo of the output phase current Io, whether the output phase current Io falls within the predetermined range RB.

The commutation control unit 43 includes, e.g., first to fourth commutation control units 51 to 54. Based on the output current polarity and the input voltage rank, the first to fourth commutation control units 51 to 54 generate a gate signal Sg pursuant to the commutation pattern of the commutation method which is included in the commutation method group selected by the commutation method selection unit 49.

The first commutation control unit 51 generates a gate signal Sg pursuant to the commutation pattern of commutation method A. The second commutation control unit 52 generates a gate signal Sg pursuant to the commutation pattern of commutation method B. The third commutation control unit 53 generates a gate signal Sg pursuant to the commutation pattern of commutation method C. The fourth commutation control unit 54 generates a gate signal Sg pursuant to the commutation pattern of commutation method D.

The selection unit 44 selects one of the first to fourth commutation control units 51 to 54, based on at least one of the determination result of the voltage determination unit 41 and the determination result of the current determination unit 42, and causes the selected commutation control unit to execute commutation control.

For example, if the inter-phase voltage of the input phases falls outside the predetermined range RA and if the output phase current Io falls within the predetermined range RB, the selection unit 44 selects the first commutation control unit 51. As another example, if the inter-phase voltage of the input phases falls within the predetermined range RA and if the output phase current Io falls outside the predetermined range RB, the selection unit 44 selects the second commutation control unit 52.

As a further example, if the inter-phase voltage of the input phases falls within the predetermined range RA and if the output phase current Io falls within the predetermined range RB, the selection unit 44 selects the third commutation control unit 53. As a still further example, if the inter-phase voltage of the input phases falls outside the predetermined range RA and if the output phase current Io falls outside the predetermined range RB, the selection unit 44 selects the fourth commutation control unit 54.

Based on the commutation control state of the commutation control unit 43, the conduction loss determination unit 45 determines the conduction loss generated by the commutation control. The conduction losses of the respective commutation methods have, for example, the relationship illustrated in FIG. 20.

The conduction loss determination unit 45 determines the conduction loss generated by the commutation control, based on, e.g., the conduction loss Pci of the commutation method i (i=A, B, C or D) used in the commutation control unit 43 and the selection ratio Ki of the commutation method i. The conduction loss determination unit 45 determines the conduction loss Pc generated by the commutation control, for example, by the calculation of the following mathematical formula (1).

P_{c}=ΣKi·P_{ci}(i=A,B,C,D) (1)

The comparison unit 46 compares the conduction loss Pc (hereinafter referred to as a conduction loss determination value) determined by the conduction loss determination unit with a conduction loss limit value Pth1. If the conduction loss determination value Pc exceeds the conduction loss limit value Pth1, the comparison unit 46 outputs a conduction loss suppression command.

Based on the commutation control state of the commutation control unit 43, the switching loss determination unit 47 determines the switching loss generated by the commutation control. The switching losses of the respective commutation methods have, for example, the relationship illustrated in FIG. 20.

The switching loss determination unit 47 determines the switching loss Ps generated by the commutation control, based on, e.g., the switching loss Psi of the commutation method i (i=A, B, C or D) used in the commutation control unit 43 and the selection ratio Ki of the commutation method i. The switching loss determination unit 47 determines the switching loss Ps generated by the commutation control, for example, by the calculation of the following mathematical formula (2).

Pₛ=ΣKi·Pₛᵢ(i=A,B,C,D) (2)

The comparison unit 48 compares the switching loss Ps (hereinafter referred to as a switching loss determination value) determined by the switching loss determination unit 47 with a switching loss limit value Pth2. If the switching loss determination value Ps exceeds the switching loss limit value Pth2, the comparison unit 48 outputs a switching loss suppression command.

Based on the comparison results obtained by the comparison units 46 and 48, the commutation method selection unit 49 selects a commutation method group for causing the commutation control unit 43 to execute commutation control, from first to fourth commutation method groups 71 to 74.

The first commutation method group 71 is, for example, a group of the commutation methods A to D which are combined so as to enhance the power conversion accuracy. In the combination which exhibits high power conversion accuracy, for example, the commutation methods A to C are the second two-step voltage commutation method or the third two-step voltage commutation method, and the commutation method D is the one-step current commutation method or the pseudo one-step current commutation method.

The second commutation method group 72 is, for example, a group of the commutation methods A to D which are combined so as to reduce the conduction loss. In the combination which reduces the conduction loss, for example, the commutation method A is the four-step current commutation method, the commutation method B is the four-step voltage commutation method, and the commutation methods C and D are the four-step current commutation method or the four-step voltage commutation method.

The third commutation method group 73 is, for example, a group of the commutation methods A to D which are combined so as to reduce the switching loss. In the combination which reduces the switching loss, for example, the commutation method A is the three-step current commutation method, the commutation method B is the second two-step voltage commutation method, and the commutation methods C and D are the three-step current commutation method or the second two-step voltage commutation method.

The fourth commutation method group 74 is, for example, a group of the commutation methods A to D which are combined so as to reduce the conduction loss and the switching loss. In the combination which reduces the conduction loss and the switching loss, for example, the commutation method A is the three-step current commutation method, the commutation method B is the three-step voltage commutation method, and the commutation methods C and D are the three-step current commutation method or the three-step voltage commutation method.

For example, if the comparison unit 46 does not output the conduction loss suppression command and if the comparison unit 48 does not output the switching loss suppression command, the commutation method selection unit 49 selects the first commutation method group 71 and sets the first commutation method group 71 in the commutation control unit 43. Thus, the commutation control using the commutation methods A to D of the first commutation method group 71 is executed by the commutation control unit 43. It is therefore possible to enhance the power conversion accuracy.

As another example, if the comparison unit 46 outputs the conduction loss suppression command and if the comparison unit 48 does not output the switching loss suppression command, the commutation method selection unit 49 selects the second commutation method group 72 and sets the second commutation method group 72 in the commutation control unit 43. Thus, the commutation control using the commutation methods A to D of the second commutation method group 72 is executed by the commutation control unit 43. It is therefore possible to reduce the conduction loss.

As a further example, if the comparison unit 46 does not output the conduction loss suppression command and if the comparison unit 48 outputs the switching loss suppression command, the commutation method selection unit 49 selects the third commutation method group 73 and sets the third commutation method group 73 in the commutation control unit 43. Thus, the commutation control using the commutation methods A to D of the third commutation method group 73 is executed by the commutation control unit 43. It is therefore possible to reduce the switching loss.

As a still further example, if the comparison unit 46 outputs the conduction loss suppression command and if the comparison unit 48 outputs the switching loss suppression command, the commutation method selection unit 49 selects the fourth commutation method group 74 and sets the fourth commutation method group 74 in the commutation control unit 43. Thus, the commutation control using the commutation methods A to D of the fourth commutation method group 74 is executed by the commutation control unit 43. It is therefore possible to reduce the conduction loss and the switching loss.

As described above, the commutation method selection unit 49 changes the commutation pattern selected by the selection unit 44, based on the determination result of the power loss generated in the bidirectional switch S by the commutation control. This makes it possible to suppress an increase of the power loss generated in the bidirectional switch S.

Furthermore, if the power loss is equal to or smaller than a predetermined limit value, the commutation method selection unit 49 selects the commutation method group having a commutation pattern in which the generation of the power loss is relatively large. If the power loss exceeds the predetermined limit value, the commutation method selection unit 49 selects the commutation method group having a commutation pattern in which the generation of the power loss is relatively small.

Accordingly, in the case where the power loss is equal to or smaller than the predetermined limit value, for example, the commutation method which exhibits high power conversion accuracy is used. This makes it possible to enhance the power conversion accuracy of the matrix converter 1. Furthermore, in the case where the power loss exceeds the predetermined limit value, it is possible to suppress an increase of the power loss of the matrix converter 1.

In the above-described embodiment, the commutation method selection unit 49 is configured to select the commutation method group. Alternatively, the commutation methods A to D may be individually changed based on the power loss. For example, with respect to some of the commutation methods A to D, the commutation method selection unit 49 may select the commutation method so that the conduction loss determination value Pc becomes equal to or smaller than the limit value. With respect to the remaining commutation methods, the commutation method selection unit 49 may select the commutation method so that the switching loss determination value Ps becomes equal to or smaller than the limit value. Furthermore, while the commutation method selection unit 49 is configured to select the commutation method group, it may be possible to change only one of the commutation methods A to D based on the conduction loss determination value Pc and the switching loss determination value Ps.

The commutation method selection unit 49 may set, for example, information of a table of decided commutation patterns in the first to fourth commutation control units 51 to 54. The first to fourth commutation control units 51 to 54 may store, for example, a table of a plurality of commutation patterns. The commutation method selection unit 49 may notify the information, which indicates the numbers of the commutation methods, to the first to fourth commutation control units 51 to 54. In this case, the first to fourth commutation control units 51 to 54 may generate gate signals Sg based on the table of the commutation patterns of the commutation methods corresponding to the numbers of the commutation methods notified from the commutation method selection unit 49.

The switching unit 50 switches a first mode in which commutation control is performed according to the commutation pattern selected by the selection unit 44 as described above and a second mode in which commutation control is performed according to a predetermined commutation pattern. In the case where the first mode is set by the switching unit 50, the commutation control unit 43 generates a gate signal Sg using the commutation control unit selected by the selection unit 44 from the first to fourth commutation control units 51 to 54.

In the case where the second mode is set by the switching unit 50, the commutation control unit 43 generates a gate signal Sg according to the commutation pattern of the predetermined commutation method (e.g., the second two-step voltage commutation method). In the second mode, the gate signal Sg is generated by, e.g., the first commutation control unit 51 among the first to fourth commutation control units 51 to 54.

In FIG. 23, there is illustrated an example where the commutation control unit 43 includes the first to fourth commutation control units 51 to 54. However, in the commutation control unit 43, all the necessary combinations of the commutation patterns of the commutation methods may be stored as a table. In this case, the commutation control unit 43 selects the commutation method pursuant to the output current polarity or the input voltage rank, from the combination of the commutation methods A to D decided by the commutation method selection unit 49, and generates a gate signal Sg according to the commutation pattern of the selected commutation method.

FIG. 26 is a diagram illustrating another example of the configuration of the commutation unit 32. As illustrated in FIG. 26, the commutation unit 32 includes a voltage determination unit 41, a current determination unit 42, a commutation control unit 43, a selection unit 44, a conduction loss determination unit 45, a switching loss determination unit 47, subtraction units 61 and 62, amplification units 63 and 64, a threshold value adjustment unit 65 (one example of a condition changer), and a switching unit 50. Instead of including both the conduction loss determination unit 45 and the switching loss determination unit 47, the commutation unit 32 may include only the conduction loss determination unit 45 or only the switching loss determination unit 47. The following descriptions will be centered on the points differing from the commutation unit 32 illustrated in FIG. 23. The components having the same functions as those of the commutation unit 32 illustrated in FIG. 23 will be designated by like reference symbols with the descriptions thereon omitted.

The subtraction unit 61 subtracts a conduction loss target value Pt1 from the conduction loss determination value Pc obtained by the conduction loss determination unit 45. The subtraction unit 62 subtracts a switching loss target value Pt2 from the switching loss determination value Ps obtained by the switching loss determination unit 47.

The amplification unit 63 multiplies the subtraction result ΔPc of the subtraction unit 61 by a gain K1 and outputs the multiplication result as a conduction loss adjustment value P1. Furthermore, the amplification unit 64 multiplies the subtraction result APs of the subtraction unit 62 by a gain K2 and outputs the multiplication result as a switching loss adjustment value P2. The threshold value adjustment unit 65 adjusts the predetermined ranges RA and RB used in the selection unit 44, based on the conduction loss adjustment value P1 and the switching loss adjustment value P2.

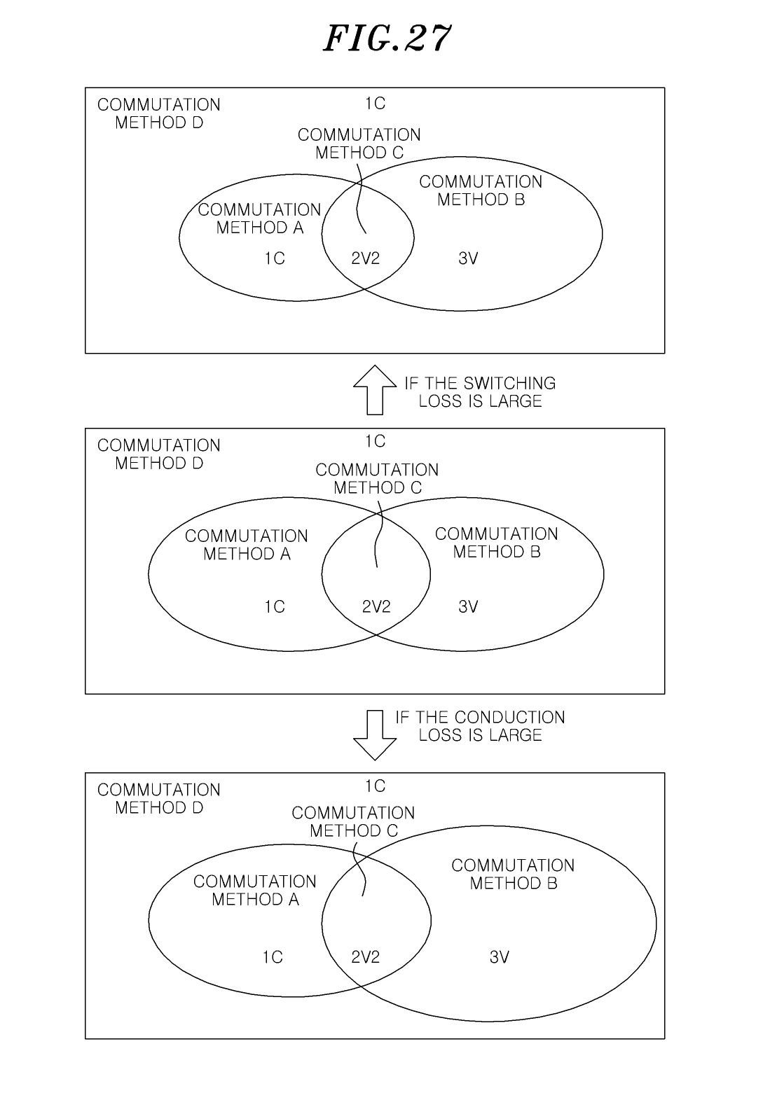

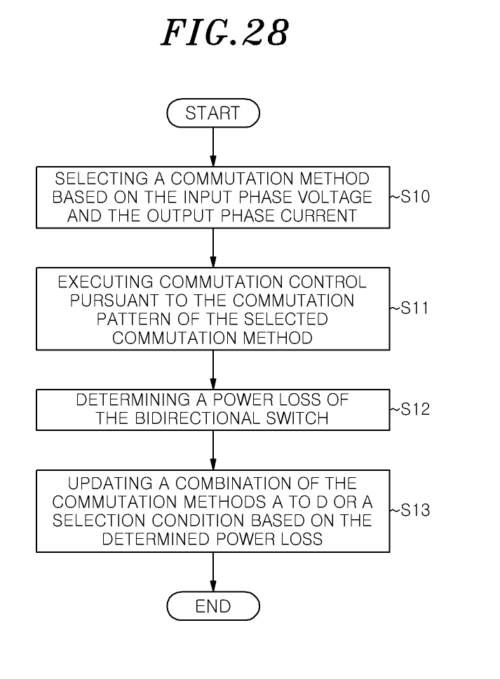

FIG. 27 is a diagram illustrating a change example of a selection ratio with respect to a power loss. FIG. 27 illustrates an example in which the commutation methods A and D are the one-step current commutation method, the commutation method B is the three-step voltage commutation method, and the commutation method C is the second two-step voltage commutation method. The second two-step voltage commutation method set as the commutation method C is large in switching loss. Thus, if the switching loss determination value Ps is large, the threshold value adjustment unit 65 reduces the predetermined range RA as illustrated in FIG. 27, thereby reducing the selection ratio of the commutation method C. The one-step current commutation method set as the commutation methods A and D is large in conduction loss. Thus, if the conduction loss determination value Pc is large, the threshold value adjustment unit 65 reduces the predetermined range RB as illustrated in FIG. 27, thereby reducing the selection ratio of the commutation method D.

As described above, the threshold value adjustment unit 65 adjusts the predetermined ranges RA and RB so that the conduction loss determination value Pc becomes equal to the conduction loss target value Pt1 and so that the switching loss determination value Ps becomes equal to the switching loss target value Pt2. This makes it possible to reduce the power loss, which is generated in the bidirectional switch S, to the target value. For example, by using the commutation method which exhibits high power conversion accuracy, it is possible to enhance the power conversion accuracy of the matrix converter 1.

The threshold value adjustment unit 65 may adjust the predetermined ranges RA and RB in the case where the conduction loss determination value Pc exceeds the conduction loss target value Pt1 or in the case where the switching loss determination value Ps exceeds the switching loss target value Pt2. In this case, the conduction loss target value Pt1 and the switching loss target value Pt2 become limit values. The conduction loss determination value Pc is limited so as to become equal to or smaller than the conduction loss target value Pt1. Furthermore, the switching loss determination value Ps is limited so as to become equal to or smaller than the switching loss target value Pt2.

The threshold value adjustment unit 65 may adjust the predetermined ranges RA and RB so as to adjust only the conduction loss determination value Pc. Moreover, the threshold value adjustment unit 65 may adjust the predetermined ranges RA and RB so as to adjust only the switching loss determination value Ps.

[5. Control Flow of Control Unit 20]

FIG. 28 is a flowchart illustrating one example of a flow of the control process performed by the control unit 20. The control unit 20 repeatedly performs the control process, which is illustrated in FIG. 28, at a predetermined cycle.

As illustrated in FIG. 28, the control unit 20 selects one of the commutation methods A to D based on the state of the input phase voltage Vi and the state of the output phase current Io (Step S10). For example, the control unit 20 selects one of the commutation methods A to D depending on whether the inter-phase voltage of the input phases falls within the predetermined range RA and whether the output phase current Io falls within the predetermined range RB.

Based on the output current polarity or the input voltage rank, the control unit 20 performs commutation control pursuant to the commutation pattern of the commutation method selected at Step S10 (Step S11).

Next, the control unit 20 determines the power loss generated in the bidirectional switch S, based on the power loss of each of the commutation methods A to D and the selection ratio of each of the commutation methods (Step S12). The power loss of each of the commutation methods A to D may be, for example, a conduction loss or a switching loss.

The control unit 20 updates the combination or the selection condition of the commutation methods A to D based on the power loss generated in the bidirectional switch S (Step S13). For example, the control unit 20 selects the combination of the commutation methods A to D so that the power loss becomes equal to or smaller than the limit value. Alternatively, the control unit 20 changes the predetermined ranges RA and RB so that the power loss becomes equal to or smaller than the limit value.

In the above-described embodiment, the combination of the commutation methods used in the commutation control is a combination of four commutation methods A to D. However, the combination of the commutation methods used in the commutation control may be a combination of two or three commutation methods or may be a combination of five or more commutation methods.

In the above-described embodiment, descriptions has been made on a case where the commutation unit 32 includes the first to fourth commutation control units 51 to 54. However, it may be possible to employ a configuration in which one commutation control unit performs commutation control pursuant to the commutation patterns of plural kinds of commutation methods.

The control unit 20 may simultaneously perform a process of selecting a combination of the commutation methods A to D so that the power loss becomes equal to or smaller than a limit value or equal to a target value and a process of changing the predetermined ranges RA and RB so that the power loss becomes equal to or smaller than a limit value or equal to a target value.

Other effects and modifications may be readily derived by those skilled in the art. For that reason, the broad aspect of the present disclosure is not limited to the specific disclosure and the representative embodiments shown and described above. Accordingly, the present disclosure can be modified in many different forms without departing from the spirit and scope defined by the appended claims and the equivalents thereof.

It should be understood by those skilled in the art that various modifications, combinations, sub-combinations and alterations may occur depending on design requirements and other factors insofar as they are within the scope of the appended claims or the equivalents thereof.

What is claimed is:

1. A matrix converter, comprising:
a power converter including a plurality of bidirectional switches provided between respective phases of an AC power source and respective phases of a load;
a selector configured to select one commutation pattern from a plurality of commutation patterns based on a state of a phase voltage of the AC power source and a state of a phase current of the load;
a commutation controller configured to perform commutation control by controlling the bidirectional switches pursuant to the commutation pattern selected by the selector to switch a connection state of the AC power source and the load;
a determinator configured to determine a power loss generated by the commutation control in the bidirectional switches; and
a condition changer configured to change the commutation patterns which become a selection target of the selector or a selection condition of the commutation patterns which become the selection target of the selector, based on the power loss determined by the determinator.

2. The matrix converter of claim 1, wherein the condition changer is configured to change a group of the commutation patterns which become the selection target of the selector, among the plurality of the commutation patterns.

3. The matrix converter of claim 2, wherein the determinator is configured to determine at least one of a conduction loss and a switching loss, which are generated by the commutation control in the bidirectional switches, to be the power loss, and
the condition changer is configured to use a group of the commutation patterns, in which generation of the power loss is relatively large, as the selection target if the power loss is equal to or smaller than a predetermined limit value and to use a group of the commutation patterns, in which generation of the power loss is relatively small, as the selection target if the power loss exceeds the predetermined limit value.

4. The matrix converter of claim 1, wherein the condition changer is configured to change the selection condition of the commutation patterns with respect to at least one of the state of the phase voltage and the state of the phase current based on the power loss determined by the determinator.

5. The matrix converter of claim 4, wherein the determinator is configured to determine at least one of a conduction loss and a switching loss, which are generated by the commutation control in the bidirectional switches, to be the power loss, and
the condition changer is configured to change the selection condition of the commutation patterns with respect to at least one of the state of the phase voltage and the state of the phase current so that the power loss becomes equal to or smaller than a predetermined limit value.

6. The matrix converter of claim 1, further comprising:
a switcher configured to switch a first mode in which commutation control is performed pursuant to the commutation pattern selected by the selector and a second mode in which commutation control is performed pursuant to a predetermined commutation pattern,
wherein the commutation controller is configured to perform the commutation control based on the mode switched by the switcher.

7. The matrix converter of claim 2, further comprising:
a switcher configured to switch a first mode in which commutation control is performed pursuant to the commutation pattern selected by the selector and a second mode in which commutation control is performed pursuant to a predetermined commutation pattern,
wherein the commutation controller is configured to perform the commutation control based on the mode switched by the switcher.

8. The matrix converter of claim 3, further comprising:
a switcher configured to switch a first mode in which commutation control is performed pursuant to the commutation pattern selected by the selector and a second mode in which commutation control is performed pursuant to a predetermined commutation pattern,
wherein the commutation controller is configured to perform the commutation control based on the mode switched by the switcher.

9. The matrix converter of claim 4, further comprising:
a switcher configured to switch a first mode in which commutation control is performed pursuant to the commutation pattern selected by the selector and a second mode in which commutation control is performed pursuant to a predetermined commutation pattern,
wherein the commutation controller is configured to perform the commutation control based on the mode switched by the switcher.

10. The matrix converter of claim 5, further comprising:
a switcher configured to switch a first mode in which commutation control is performed pursuant to the commutation pattern selected by the selector and a second mode in which commutation control is performed pursuant to a predetermined commutation pattern,
wherein the commutation controller is configured to perform the commutation control based on the mode switched by the switcher.

11. A matrix converter control device, comprising:
a selector configured to select one commutation pattern from plurality of commutation patterns based on states of respective phases of an AC power source and respective phases of a load which are connected to each other via a power converter having a plurality of bidirectional switches;
a commutation controller configured to perform commutation control by controlling the bidirectional switches pursuant to the commutation pattern selected by the selector to switch a connection state of the AC power source and the load;
a determinator configured to determine a power loss generated by the commutation control in the bidirectional switches; and
a condition changer configured to change the commutation patterns which become a selection target of the selector or a selection condition of the commutation patterns which become the selection target of the selector, based on the power loss determined by the determinator.

12. A matrix converter control method, comprising:
selecting one commutation pattern from plurality of commutation patterns based on states of respective phases of an AC power source and respective phases of a load which are connected to each other via a power converter having a plurality of bidirectional switches;
performing commutation control by controlling the bidirectional switches pursuant to the commutation pattern selected in said selecting to switch a connection state of the AC power source and the load;
determining a power loss generated by the commutation control in the bidirectional switches; and
changing the commutation patterns which become a selection target in said selecting or a selection condition of the commutation patterns which become the selection target in said selecting, based on the power loss determined in said determining.
